(19) United States
(12) Patent Application Publication
(10) Pub. No.: US 2010/0182498 A1
(43) Pub. Date: Jul. 22, 2010

(54) SOLID-STATE IMAGE PICKUP APPARATUS

(75) Inventors: Hiromitsu Niwa, Anpachi-gun (JP); Ken Yoshida, Ota-shi (JP)

Correspondence Address: DITTHAVONG MORI & STEINER, P.C., 918 Prince Street, Alexandria, VA, 22314, US

(73) Assignee: Sanyo Electric Co., Ltd., Moriguchi-shi (JP)

(21) Appl. No.: 12/644,808

(22) Filed: Dec. 22, 2009

(30) Foreign Application Priority Data
Jan. 20, 2009 (JP) 2009-10188

(51) Int. Cl. H04N 5/225

(52) U.S. Cl. 348/374; 348/E05.024

(57) ABSTRACT

A solid-state image pickup apparatus includes a metal plate having at least one of surfaces which consists of a planar surface and an image sensor directly mounted on the surface of the metal plate through an adhesive layer, wherein the metal plate is provided with a hole-shaped or notch-shaped positioning portion for performing positioning in a direction parallel to the surface consisting of the planar surface of the metal plate.

### CROSS-REFERENCE TO RELATED APPLICATIONS

The priority application number JP2009-10188, Solid-State Image Pickup Apparatus, Jan. 20, 2009, Hiromitsu Niwa and Ken Yoshida, upon which this patent application is based is hereby incorporated by reference.

### BACKGROUND OF THE INVENTION

1. Field of the Invention

The present invention relates to a solid-state image pickup apparatus, and more particularly, it relates to a solid-state image pickup apparatus comprising an image sensor provided on a metal plate.

2. Description of the Background Art

A solid-state image pickup apparatus comprising an image sensor provided on a metal plate is known in general.

A solid-state image pickup apparatus in which a metal plate (frame) having a projecting portion, a circuit board, a frame portion and an image sensor are arranged to be stacked is disclosed in general. The circuit board and the frame portion are provided with respective openings to pass through, and the frame portion is so mounted on the circuit board that the opening of the circuit board and the opening of the frame portion overlap with each other in plan view. The image sensor is so mounted on the frame portion that the opening of the circuit board and the opening of the frame portion overlap with each other in plan view. The image sensor and the projecting portion of the metal plate are brought into contact with each other through the opening of the circuit board and the opening of the frame portion, and the circuit board and a recess portion provided around the projecting portion of the metal plate are fixed by an adhesive layer, thereby positioning the image sensor.

### SUMMARY OF THE INVENTION

A solid-state image pickup apparatus according to an aspect of the present invention comprises a metal plate having at least one of surfaces which consists of a planar surface and an image sensor directly mounted on the surface consisting of the planar surface of the metal plate through an adhesive layer, wherein the metal plate is provided with a hole-shaped or notch-shaped positioning portion for performing positioning in a direction parallel to the surface consisting of the planar surface of the metal plate.

In this solid-state image pickup apparatus according to the aspect of the present invention, positioning of the image sensor can be easily performed by the aforementioned structure.

### BRIEF DESCRIPTION OF THE DRAWINGS

FIG. 1 is a perspective view of a solid-state image pickup apparatus according to an embodiment of the present invention;

FIG. 2 is a perspective view of an image sensor portion mounted on a mounting base of the solid-state image pickup apparatus according to the embodiment of the present invention;

FIG. 3 is an exploded perspective view of the image sensor portion of the solid-state image pickup apparatus according to the embodiment of the present invention;

FIG. 4 is a plan view of a metal plate of the solid-state image pickup apparatus according to the embodiment of the present invention;

FIG. 5 is a plan view of the mounting base of the solid-state image pickup apparatus according to the embodiment of the present invention;

FIG. 6 is a sectional view taken along the line 200-200 in FIG. 1;

FIG. 7 is a sectional view taken along the line 300-300 in FIG. 1;

FIG. 8 is a perspective view showing a state of being mounted with the mounting base of the solid-state image pickup apparatus according to the embodiment of the present invention;

FIGS. 9 to 11 are diagrams for illustrating the procedure of assembling the image sensor portion of the solid-state image pickup apparatus according to the embodiment of the present invention;

FIG. 12 is a plan view showing a modification of the metal plate of the solid-state image pickup apparatus according to the embodiment of the present invention; and

FIG. 13 is a plan view showing a modification of the image sensor portion of the solid-state image pickup apparatus according to the embodiment of the present invention.

### DESCRIPTION OF THE PREFERRED EMBODIMENTS

Embodiments of the present invention will be hereinafter described with reference to the drawings.

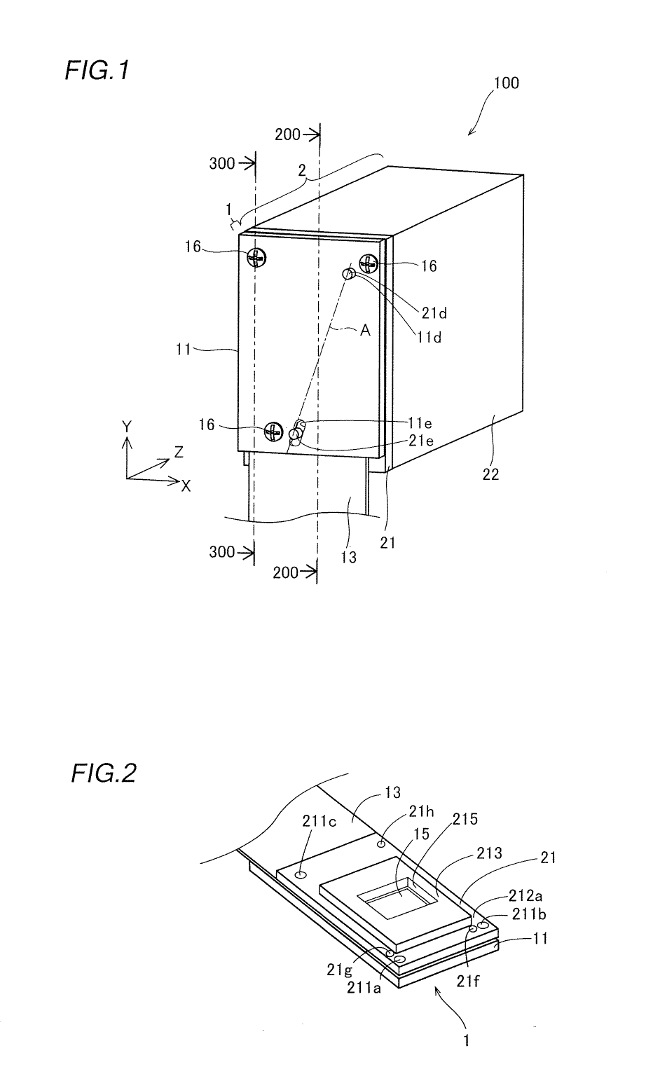

A structure of a solid-state image pickup apparatus 100 according to an embodiment of the present invention will be now described with reference to FIGS. 1 to 7.

The solid-state image pickup apparatus 100 according to the embodiment of the present invention includes an image sensor portion 1 storing an image sensor 12 described later and a lens portion 2 storing a lens 23, as shown in FIG. 1.

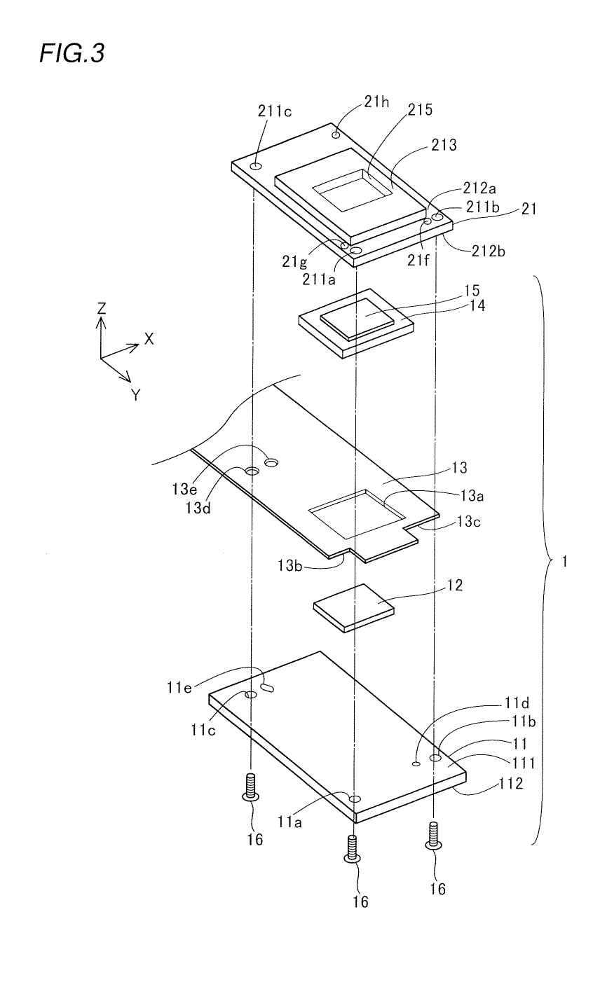

As shown in FIGS. 2 and 3, the image sensor portion 1 is constituted by a metal plate 11, the image sensor 12, a flexible printed circuit (FPC) board 13, a base mount 14, and an infrared ray cut filter (IRCF) 15. The FPC 13 is an example of the “circuit board” in the present invention, and the base mount 14 is an example of the “frame portion” in the present invention. The infrared ray cut filter 15 is an example of the “filter” in the present invention. As shown in FIG. 2, the image sensor portion 1 is so formed as to be mounted on a mounting base 21 provided on a lens portion 2 side. The infrared ray cut filter 15 is so formed as to be exposed from an opening 215 of the mounting base 21.

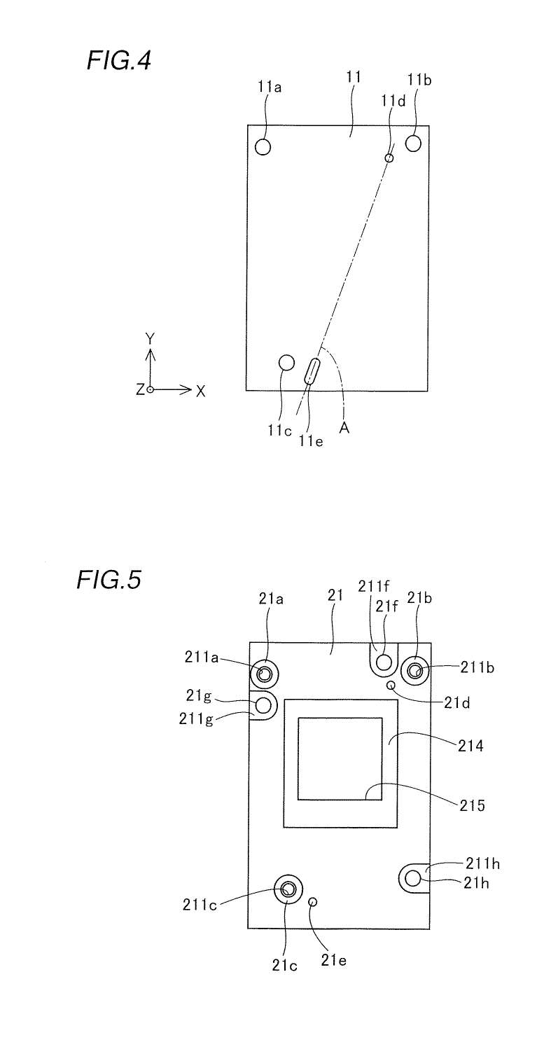

According to this embodiment, the metal plate 11 is made of a rectangular flat plate in plan view and has a surface 111 constituted by a planar surface. The metal plate 11 is made of metal such as copper (Cu) having a thickness of about 1 mm. In other words, the metal plate 11 consists of a thin plate having both surfaces consisting of the planar surfaces. The metal plate 11 has a function of radiating heat generated from the image sensor 12. As shown in FIG. 4, the metal plate 11 is provided with three screw receiving holes 11a, 11b and 11c for mounting the metal plate 11 on the mounting base 21 by screws 16. The screw receiving holes 11a, 11b and 11c are provided on regions of the metal plate 11, corresponding to mounting portions 21a, 21b and 21c (see FIG. 5) provided on the mounting base 21.

According to this embodiment, a positioning circular hole 11d and a positioning long hole 11e are provided on regions of the metal plate 11, corresponding to a positioning pin 21d and a positioning pin 21e (see FIG. 5) provided on the mounting base 21. The positioning circular hole 11d and the positioning long hole 11e are examples of the “first positioning portion” and the “second positioning portion” in the present invention, respectively. The positioning circular hole 11d and the positioning long hole 11e are provided for positioning in a direction (directions X and Y) parallel to the surface 111 consisting of the planar surface of the metal plate 11. The positioning circular hole 11d is formed in a circular hole shape and the positioning long hole 11e is formed in a long hole shape. According to this embodiment, the positioning circular hole 11d and the positioning long hole 11e are so arranged that a center of the circular hole of the positioning circular hole 11d is located on a central line A of the long hole in a direction parallel to a long side of the long hole-shaped positioning long hole 11e. The positioning circular hole 11d and the positioning long hole 11e are provided on a first end side and a second end side of a longitudinal direction of the rectangular metal plate 11, respectively. The positioning circular hole 11d and the positioning long hole 11e are provided on a diagonal position of the rectangular metal plate 11. The screw receiving holes 11b and 11c are provided in the vicinity of the positioning circular hole 11d and the positioning long hole 11e, respectively.

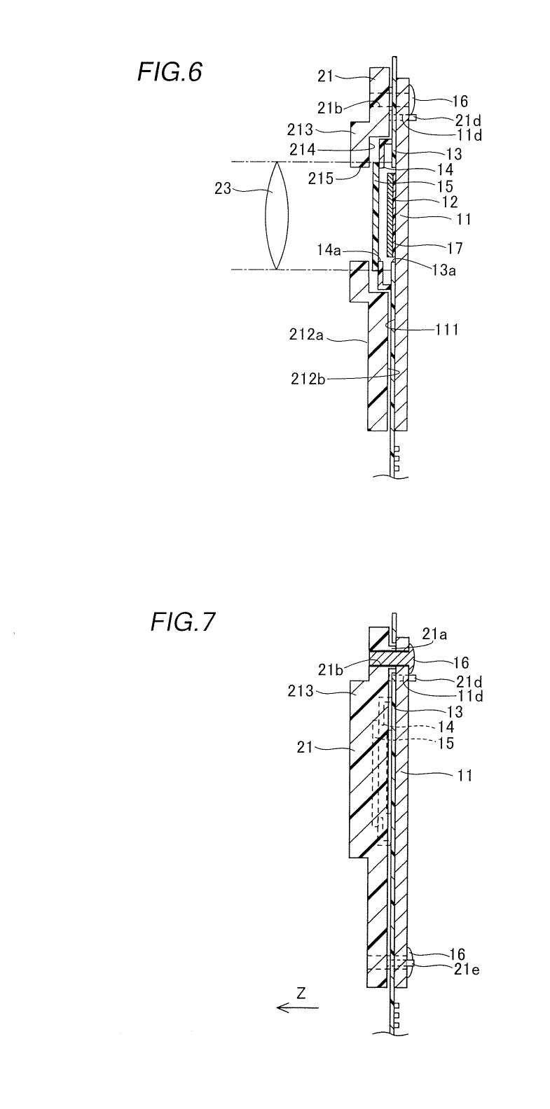

According to this embodiment, the image sensor 12 is so formed as to be directly mounted on the surface 111 consisting of the planar surface of the metal plate 11 through an adhesive layer 17, as shown in FIG. 6. The image sensor 12 consists of a rectangular CMOS sensor having a thickness of at least about 0.2 mm and not more than about 0.3 mm. The adhesive layer 17 preferably has a thickness of about several 10 μm and is preferably made of a material having excellent thermal conduction.

The FPC 13 has a thickness of at least about 0.1 mm and not more than about 0.2 mm, and is so formed as to be mounted on the surface 111 consisting of the planar surface of the metal plate 11 by thermal compression bond. The FPC 13 is provided with an opening 13a on a region corresponding to the image sensor 12. As shown in FIG. 3, the FPC 13 is so provided with notches 13b and 13c that the screw receiving hole 11a, the screw receiving hole 11b and the positioning circular hole 11d of the metal plate 11 are exposed. The FPC 13 is provided with openings 13d and 13e on regions corresponding to the screw receiving hole 11c and the positioning long hole 11e of the metal plate 11, respectively. The FPC 13 is so formed as to be connected to an image processing circuit (not shown). The opening 13e is an example of the “first relief portion” in the present invention. The opening 13d is an example of the “second relief portion” in the present invention.

As shown in FIG. 3, the base mount 14 is formed in a rectangular shape in plan view, and is provided with an opening 14a (see FIG. 6) on a region corresponding to the image sensor 12. As shown in FIG. 6, the base mount 14 is so mounted on the FPC 13 around the opening 13a of the FPC 13 as to enclose a periphery of the image sensor 12. The infrared ray cut filter 15 is formed in a rectangular shape in plan view, and is arranged to overlap with the image sensor 12.

The lens portion 2 is constituted by the mounting base 21, a housing 22 (see FIG. 1) and the lens 23 (see FIG. 6). The housing 22 is formed in a box shape, and is formed to store the lens 23. The housing 22 is formed to be mounted with the mounting base 21.

As shown in FIG. 6, a rectangular projecting portion 213 is provided on a surface 212a of the mounting base 21 in plan view, and a rectangular recess portion 214 is provided on a region of the rear surface 212b corresponding to the projecting portion 213 in plan view. The mounting base 21 is made of resin and the like. The recess portion 214 of the mounting base 21 is so formed that the image sensor 12, the base mount 14, and the infrared ray cut filter 15 are stored in the recess portion 214 in a state where the metal plate 11 is mounted on the mounting base 21 with the FPC 13 therebetween by the screws 16. The opening 215 is provided on a region, corresponding to the image sensor 12, of the projecting portion 213 of the mounting base 21.

As shown in FIG. 5, the mounting portions 21a to 21c coming into contact with the metal plate 11 is provided on the mounting base 21 when the metal plate 11 is mounted on the mounting base 21. The mounting portions 21a to 21c are provided on both of a first end side and a second end side of the mounting base 21. The mounting portions 21a to 21c are circularly formed in plan view, and threaded holes 211a to 211c for mounting the metal plate 11 on the mounting base 21 by the screws 16 are provided on central portions of the mounting portions 21a to 21c, respectively. As shown in FIG. 7, the mounting portion 21a protrudes from the mounting base 21 to the metal plate 11 side, and is formed in a cylindrical shape in which a surface of the mounting portion 21a on the metal plate 11 side is flatly formed. The mounting portions 21b and 21c are formed in shapes similar to the shape of the mounting portion 21a. According to this embodiment, the metal plate 11 and the mounting base 21 are fixed by fitting the screws 16 into the threaded holes 211a to 211c through the screw receiving holes 11a to 11c of the metal plate 11 in a state where the metal plate 11 is in contact with the mounting portions 21a to 21c of the mounting base 21, thereby performing positioning in a direction (direction Z) perpendicular to the surface 111 consisting of the planar surface of the metal plate 11.

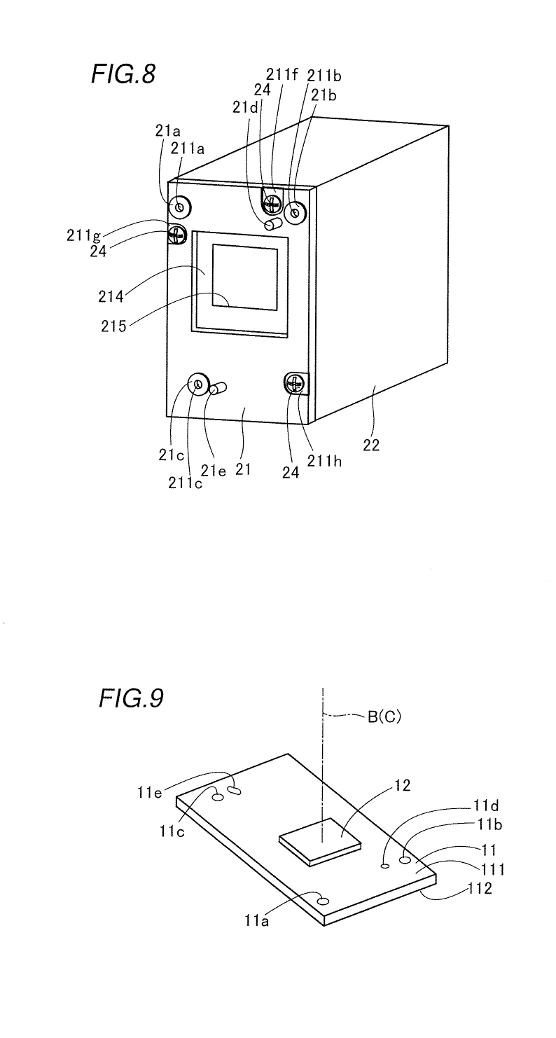

The mounting base 21 is provided with screw receiving holes 21f, 21g and 21h for mounting the mounting base 21 on the housing 22 by the screws 24 (see FIG. 8). The peripheral portions 211f, 211g and 211h provided with the screw receiving holes 21f to 21h of the mounting base 21 are formed in concaved shapes as compared with a portion other than portions provided with the screw receiving holes 21f to 21h of the mounting base 21, as shown in FIG. 8. Thus, the screws 24 are inhibited from protruding from a surface of the mounting base 21 when mounting the metal plate 11 on the mounting base 21, and hence the metal plate 11 is inhibited from separating from the mounting base 21.

As shown in FIGS. 1 and 8, the mounting base 21 is provided with the positioning pins 21d and 21e for performing the positioning in the direction (directions X and Y) parallel to the surface 111 consisting of the planar surface of the metal plate 11, and the positioning pins 21d and 21e are cylindrically formed to protrude from the mounting base 21 to the metal plate 11 side. The positioning pin 21d and the positioning pin 21e are examples of the “first positioning pin” and the “second positioning pin” in the present invention, respectively.

A procedure of assembling the solid-state image pickup apparatus 100 according to the embodiment of the present invention will be now described with reference to FIGS. 1 and 8 to 11.

As shown in FIG. 8, the mounting base 21 is mounted on the housing 22 by fastening the screws 24 to threaded holes (not shown) of the housing 22 of the lens portion 2 through the screw receiving holes 21f to 21h (see FIG. 5) of the mounting base 21.

As shown in FIG. 9, the image sensor 12 is directly mounted on the surface 111 consisting of the planar surface of the metal plate 11 by the adhesive layer 17 (see FIG. 6). The image sensor 12 is so mounted that a normal direction B of the surface of the image sensor 12 coincides with a normal direction C of the surface 111 consisting of the planar surface of the metal plate 11. The image sensor 12 is mounted on the surface 111 of the metal plate 11 with reference to the positioning circular hole 11d and the positioning long hole 11e for performing the positioning in the direction X-Y.

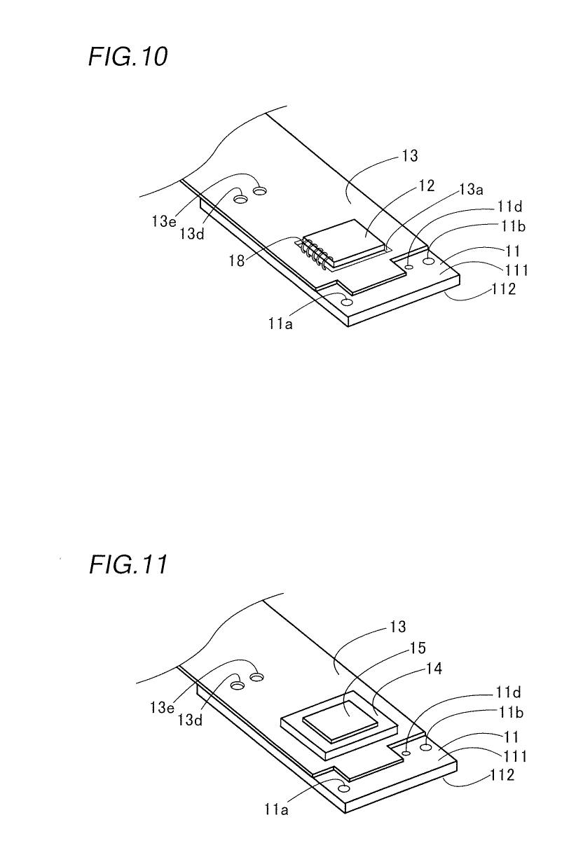

As shown in FIG. 10, the FPC 13 is mounted on the surface 111 consisting of the planar surface of the metal plate 11 by thermal compression bond or the like. At this time, the image sensor 12 is mounted to be exposed from the opening 13a of the FPC 13. A wire (not shown) on the FPC 13 and the image sensor 12 are connected by a bonding wire 18.

As shown in FIG. 11, the base mount 14 is mounted on the surface of the FPC 13 to cover the opening 13a of the FPC 13, the image sensor 12 and the bonding wire 18. The base mount 14 is formed to enclose the image sensor 12. The infrared ray cut filter 15 is mounted on the surface of the base mount 14 to overlap with the image sensor 12 in plan view.

As shown in FIG. 1, the metal plate 11 is so mounted on the mounting base 21 that the positioning pins 21d and 21e of the mounting base 21 pass through (are inserted into) the positioning circular hole 11d and the positioning long hole 11e provided on the metal plate 11, respectively. In other words, the positioning pins 21d and 21e of the mounting base 21 are in a state of protruding from the surface of the metal plate 11 on a side opposite to a side provided with the image sensor 12. Thus, the positioning of the metal plate 11 in the direction (directions X and Y) parallel to the surface 111 consisting of the planar surface of the metal plate 11 is performed. The positioning long hole 11e is formed in the long hole shape, so that the metal plate 11 can be easily mounted even when the position of the positioning circular hole 11d or the positioning long hole 11e is deviated in a direction of the central line A of the positioning long hole 11e.

The surfaces of the mounting portions 21a to 21c (see FIG. 7) of the mounting base 21 consist of the planar surfaces, so that the positioning of the metal plate 11 in the direction Z is performed in a state where the metal plate 11 and the mounting base 21 are in contact with each other. The screws 16 are fastened to the threaded holes 211a to 211c (see FIG. 8) of the mounting portions 21a to 21c of the mounting base 21 through the screw receiving holes 11a to 11c provided on the metal plate 11, thereby fixing the metal plate 11 to the mounting base 21.

According to this embodiment, as hereinabove described, the image sensor 12 is directly mounted on the surface 111 consisting of the planar surface of the metal plate 11 through the adhesive layer 17, whereby the image sensor 12 is mounted on the metal plate 11 through a single member (adhesive layer 17) dissimilarly to a case where the image sensor 12 is mounted on the metal plate through a plurality of members such as the frame portion or the printed circuit board, and hence the image sensor can be easily positioned. In other words, when the image sensor 12 is mounted on the metal plate through the plurality of members such as the frame portion or the printed circuit board, the plurality of members are stacked and hence a possibility of causing positional deviation (tilt) in the normal direction (direction Z) of the surface of the image sensor 12 is increased, while when the image sensor 12 is mounted on the metal plate 11 through the single member (adhesive layer 17), the positional deviation (tilt) in the normal direction of the surface of the image sensor 12 can be reduced.

According to this embodiment, as hereinabove described, the surface 111 of the metal plate 11 is the planar surface, whereby the image sensor 12 is inhibited from wobbling in the normal direction (direction Z) with respect to the surface of the image sensor 12 dissimilarly to a case where the projecting portion is provided on the surface of the metal plate 11 and the image sensor 12 is mounted on this projecting portion, for example. The surface 111 of the metal plate 11 is the planar surface, whereby a thickness of the solid-state image pickup apparatus 100 can be reduced due to the planar surface 111 of the metal plate 11 dissimilarly to a case where the projecting portion is provided on the surface of the metal plate 11.

According to this embodiment, as hereinabove described, the positioning circular hole 11d and the positioning long hole 11e for performing the positioning in the direction parallel to the surface consisting of the planar surface of the metal plate 11 are provided on the metal plate 11, whereby the metal plate 11 is positioned with respect to the mounting base 21 by the two positioning circular hole 11d and positioning long hole 11e, and hence the positioning in the direction parallel to the surface 111 consisting of the planar surface of the metal plate 11 can be easily preformed.

According to this embodiment, as hereinabove described, the positioning circular hole 11d provided on the region corresponding to the positioning pin 21d of the mounting base 21 and the positioning long hole 11e provided on the region corresponding to the positioning pin 21e of the mounting base 21 are provided, whereby the metal plate 11 can be easily mounted on the mounting base 21 by passing the positioning pins 21d and 21e through the positioning circular hole 11d and positioning long hole 11e, respectively. Further, the positioning long hole 11e is formed in the long hole shape, and the positioning circular hole 11d and the positioning long hole 11e are so arranged that the center of the positioning circular hole 11d is located on the central line A in the direction parallel to the long side of the positioning long hole 11e, whereby the positioning long hole 11e is formed in the long hole shape also when the positioning circular hole 11d and the positioning long hole 11e are arranged to be deviated on central line A, and hence the metal plate 11 can be easily mounted on the mounting base 21.

According to this embodiment, as hereinabove described, the positioning in the direction (direction Z) perpendicular to the surface 111 consisting of the planar surface of the metal plate 11 is performed by fixing in the state where the surface 111 consisting of the planar surface of the metal plate 11 and the mounting portions 21a to 21c of the mounting base 21 are in contact with each other, whereby the positioning is performed only by brining the metal plate 11 into contact with the mounting base 21 dissimilarly to a case where the positioning in the direction Z is performed by a spring member or an adhesive layer, and hence the positioning in the direction Z of the metal plate 11 can be easily performed.

According to this embodiment, as hereinabove described, the solid-state image pickup apparatus 100 comprises the FPC 13 mounted on the surface 111 consisting of the planar surface of the metal plate 11 and having the opening 13a on the region corresponding to the image sensor 12, whereby a thickness of the FPC 13 is smaller than a thickness of the printed circuit board dissimilarly to a case where the printed circuit board is employed in place of the FPC 13, and hence a thickness of the solid-state image pickup apparatus 100 can be reduced.

According to this embodiment, as hereinabove described, the positioning circular hole 11d is provided on the first end side of the metal plate 11 in the longitudinal direction, and the positioning long hole 11e is provided on the second end side of the metal plate 11 in the longitudinal direction. Thus, the metal plate 11 can be reliably positioned dissimilarly to a case where both of the positioning circular hole 11d and the positioning long hole 11e are provided on a particular end side of the metal plate 11.

According to this embodiment, as hereinabove described, the positioning circular hole 11d and the positioning long hole 11e are provided on the diagonal position of the rectangular metal plate 11. Thus, the metal plate 11 can be reliably positioned dissimilarly to the case where both of the positioning circular hole 11d and the positioning long hole 11e are provided on the particular end side of the metal plate 11, for example.

According to this embodiment, as hereinabove described, the positioning pins 21d and 21e of the mounting base 21 are inserted into the positioning circular hole 11d and the positioning long hole 11e of the metal plate 11, respectively, whereby the metal plate 11 is so formed as to be mounted on the mounting base 21. Thus, the metal plate 11 can be easily mounted on the mounting base 21.

According to this embodiment, as hereinabove described, the positioning pins 21d and 21e of the mounting base 21 are formed to be in the state of protruding from the surface of the metal plate 11 on the side opposite to the side provided with the image sensor 12 when the metal plate 11 is mounted on the mounting base 21. Thus, it is possible to easily visually recognize that the metal plate 11 is mounted on the mounting base 21.

According to this embodiment, as hereinabove described, the metal plate 11 consists of the thin plate having the both surfaces consisting of the planar surfaces, whereby a thickness of the image sensor portion 1 can be easily reduced.

According to this embodiment, as hereinabove described, the metal plate 11 constituting of the thin plate is made of the material (Cu) having heat radiability, whereby heat generated from the image sensor 12 can be easily radiated.

According to this embodiment, as hereinabove described, the screw receiving holes 11a to 11c for mounting the metal plate 11 on the mounting portions 21a to 21c of the mounting base 21 by the screws 16 are provided on the metal plate 11. Thus, the metal plate 11 can be easily mounted on the mounting base 21 by the screws 16.

According to this embodiment, as hereinabove described, the screw receiving holes 11b and 11c of the metal plate 11 are provided in the vicinity of the positioning circular hole 11d and the positioning long hole 11e, respectively. Thus, the metal plate 11 can be reliably mounted on the mounting base 21 while performing the positioning of the metal plate 11.

According to this embodiment, as hereinabove described, the mounting portions 21a to 21c are formed to protrude from the mounting base 21 to the metal plate 11 side, and the surfaces of the mounting portions 21a to 21c on the metal plate 11 side is flatly formed. Thus, precision in the positioning in the direction Z with respect to the mounting base 21 of the metal plate 11 can be improved.

According to this embodiment, as hereinabove described, the mounting portions 21a to 21c are provided on both of the first end side and the second end side of the mounting base 21. Thus, the metal plate 11 can be reliably mounted on the mounting base 21 dissimilarly to a case where the mounting portions 21a to 21c are provided on a particular end side of the mounting base 21.

According to this embodiment, as hereinabove described, the notch 13c and the opening 13e are provided on the regions of the FPC 13, corresponding to the positioning circular hole 11d and the positioning long hole 11e, respectively. Thus, the positioning pins 21d and 21e of the mounting base 21 can be easily brought into the state of protruding from the metal plate 11.

According to this embodiment, as hereinabove described, the notch 13b and the opening 13d are provided on the regions of the FPC 13, corresponding to the screw receiving holes 11a to 11c. Thus, the metal plate 11 can be easily mounted on the mounting base 21 by the screws 16.

According to this embodiment, as hereinabove described, the FPC 13 is mounted on the metal plate 11 by the thermal compression bond. Thus, the thickness of the image sensor portion 1 can be reduced dissimilarly to a case where the FPC 13 is mounted on the metal plate 11 by the adhesive layer, for example.

Although the present invention has been described and illustrated in detail, it is clearly understood that the same is by way of illustration and example only and is not to be taken by way of limitation, the spirit and scope of the present invention being limited only by the terms of the appended claims.

For example, while the surface 111 of the metal plate 11 is the planar surface and the surface 112 opposed to the surface 111 is also the planar surface in the aforementioned embodiment, the present invention is not restricted to this, but a fin for radiating heat may be provided on the surface 112. Thus, heat generated from the image sensor 12 can be further effectively radiated.

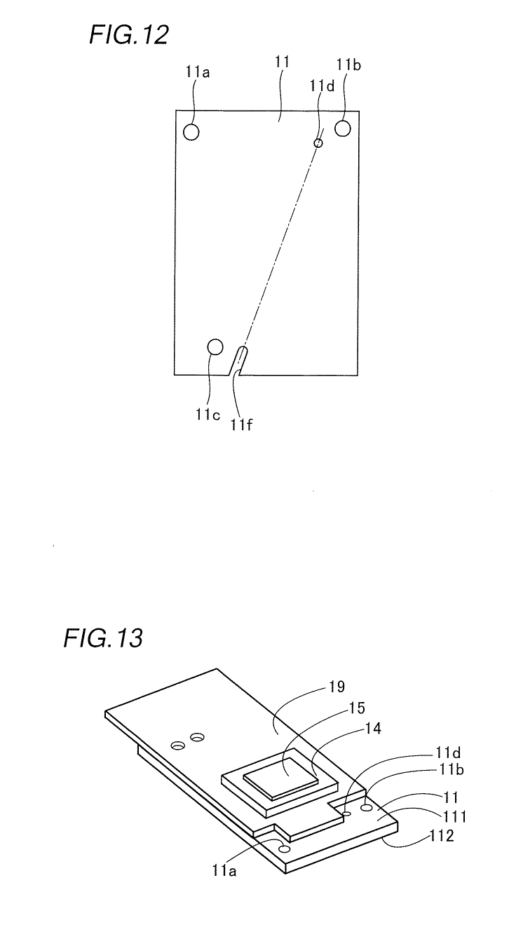

While the positioning long hole 11e is provided on the metal plate 11 in the aforementioned embodiment, the present invention is not restricted to this, but a positioning portion 11f consisting a long hole-shaped notch may be provided on the metal plate 11, as shown in FIG. 12. The positioning portion 11f is an example of the “second positioning portion” in the present invention. In this case, the positioning portion 11f and the positioning circular hole 11d are so arranged that the center of the positioning circular hole 11d consisting of the circular hole is located on the central line A in the direction parallel to the long side of the positioning portion 11f consisting of the notch.

While the FPC 13 is mounted on the surface 111 of the metal plate 11 in the aforementioned embodiment, the present invention is not restricted to this, but a printed circuit board 19 is mounted on the surface 111 of the metal plate 11, as shown in FIG. 13. The printed circuit board 19 is an example of the “circuit board” in the present invention.

While the infrared ray cut filter 15 is provided on the base mount 14 to be opposed to the image sensor 12 in the aforementioned embodiment, the present invention is not restricted to this, but a filter blocking light other than infrared ray may be provided on the base mount 14.

While the metal plate 11 made of copper (Cu) is employed in the aforementioned embodiment, the present invention is not restricted to this, but a metal plate made of aluminum (Al) or stainless may be employed.

While the rectangular metal plate 11 is employed in plan view in the aforementioned embodiment, the present invention is not restricted to this, but a metal plate other than the rectangular metal plate may be employed so far as at least one of the surfaces is a planar surface.

While the two positioning circular hole 11d and positioning long hole 11e are provided on the metal plate 11 in the aforementioned embodiment, the present invention is not restricted to this, but three or more positioning portions may be provided on the metal plate 11.

While the CMOS sensor is employed as the image sensor 12 in the aforementioned embodiment, the present invention is not restricted to this, but a sensor other than the CMOS sensor may be employed as an image sensor.

What is claimed is:

1. A solid-state image pickup apparatus comprising:
a metal plate having at least one of surfaces which consists of a planar surface; and
an image sensor directly mounted on said surface consisting of the planar surface of said metal plate through an adhesive layer, wherein
said metal plate is provided with a hole-shaped or notch-shaped positioning portion for performing positioning in a direction parallel to said surface consisting of the planar surface of said metal plate.

2. The solid-state image pickup apparatus according to claim 1, wherein
said positioning portion includes a first positioning portion consisting of a circular hole, provided on a region corresponding to a first positioning pin of a mounting base and a second positioning portion consisting of a long hole-shaped hole or a notch, provided on a region corresponding to a second positioning pin of said mounting base, and
said first and second positioning portions are so arranged that a center of said first positioning portion consisting of said circular hole is located on a central line of said long hole-shaped hole or said notch in a direction parallel to a long side of said second positioning portion consisting of said long hole-shaped hole or said notch.

3. The solid-state image pickup apparatus according to claim 2, wherein
said first positioning portion is provided on a first end side of a longitudinal direction of said metal plate, and said second positioning portion is provided on a second end side of the longitudinal direction of said metal plate.

4. The solid-state image pickup apparatus according to claim 3, wherein
said metal plate is formed in a rectangular shape, and
said first and second positioning portions are provided on a diagonal position of said rectangular metal plate.

5. The solid-state image pickup apparatus according to claim 2, wherein
said first and second positioning pins of said mounting base are inserted into said first and second positioning portions of said metal plate, respectively, so that said metal plate is mounted on said mounting base.

6. The solid-state image pickup apparatus according to claim 5, wherein
said first and second positioning pins of said mounting base are formed to be in a state of protruding from a surface of said metal plate on a side opposite to a side mounted with said image sensor in a case where said metal plate is mounted on said mounting base.

7. The solid-state image pickup apparatus according to claim 1, wherein
said metal plate consists of a thin plate having both surfaces consisting of planar surfaces.

8. The solid-state image pickup apparatus according to claim 7, wherein
said metal plate consisting of said thin plate is made of a material having heat radiability.

9. The solid-state image pickup apparatus according to claim 1, wherein
said metal plate is mounted on a mounting portion of a mounting base, and
positioning in a direction perpendicular to said surface consisting of the planar surface of said metal plate is performed by fixing in a state where said surface consisting of the planar surface of said metal plate and said mounting portion of said mounting base are in contact with each other.

10. The solid-state image pickup apparatus according to claim 9, wherein
said metal plate is provided with a screw receiving hole for mounting said metal plate on said mounting portion of said mounting base by a screw.

11. The solid-state image pickup apparatus according to claim 10, wherein
said screw receiving hole of said metal plate is provided in the vicinity of said positioning portion.

12. The solid-state image pickup apparatus according to claim 9, wherein
said mounting portion is formed to protrude from said mounting base to said metal plate side, and a surface of said mounting portion on said metal plate side is flatly formed.

13. The solid-state image pickup apparatus according to claim 12, wherein
a plurality of said mounting portions are provided, and
said mounting portions are provided on both of a first end side and a second end side of said mounting base.

14. The solid-state image pickup apparatus according to claim 1, further comprising a circuit board mounted on said surface consisting of the planar surface of said metal plate and having an opening on a region corresponding to said image sensor, wherein
a notch or a hole-shaped first relief portion is provided on a region of said circuit board, corresponding to said positioning portion.

15. The solid-state image pickup apparatus according to claim 14, wherein
said metal plate is provided with a screw receiving hole for mounting said metal plate on a mounting portion of a mounting base by a screw, and
a notch or a hole-shaped second relief portion is provided on a region of said circuit board, corresponding to said screw receiving hole.

16. The solid-state image pickup apparatus according to claim 14, wherein
said circuit board includes a flexible printed circuit board.

17. The solid-state image pickup apparatus according to claim 16, wherein
said circuit board consisting of said flexible printed circuit board is mounted on said metal plate by thermal compression bond.

18. The solid-state image pickup apparatus according to claim 1, further comprising:
a frame portion provided to enclose said image sensor and having an opening on a region corresponding to said image sensor, and
a filter provided on said frame portion to be opposed to said image sensor and blocking light having a prescribed range of wavelength.

19. The solid-state image pickup apparatus according to claim 18, further comprising a circuit board mounted on said surface consisting of the planar surface of said metal plate and having an opening on the region corresponding to said image sensor, wherein
said frame portion is mounted on a surface of said circuit board on a side mounted with said image sensor in a state of enclosing said image sensor.
